(19) United States
(12) Patent Application Publication
(10) Pub. No.: US 2024/0385784 A1
(43) Pub. Date: Nov. 21, 2024

(54) SYSTEM AND METHOD

(71) Applicant: CANON KABUSHIKI KAISHA, Tokyo (JP)

(72) Inventor: KOICHI TSUJIMOTO, Kanagawa (JP)

(21) Appl. No.: 18/666,669

(22) Filed: May 16, 2024

(30) Foreign Application Priority Data
May 17, 2023 (JP) 2023-081803

(51) Int. Cl. G06F 3/12

(52) U.S. Cl. CPC G06F 3/121; G06F 3/1234; G06F 3/1273

(57) ABSTRACT

A system is configured to perform estimating a target portion, details, and a priority for each of at least one first job required for resolving an error of a device based on error data indicating details of the error having occurred in the device and history data associated with the device, providing first job data indicating the target portion of the first job, the details of the first job, and the priority of the first job for each of the at least one first job, receiving second job data indicating a target portion and details for each of at least one second job which is executed on the device to resolve the error of the device, and storing a sequence in which the at least one second job identified based on the second job data is executed for use as feedback in estimation in a first job.

### BACKGROUND

### Field

The present disclosure relates to a system and a method.

### Description of the Related Art

In the related art, a system for managing information and states of a device such as a printer (hereinafter referred to as a “device”) has been constructed. In such a system, when a defect, a failure, or the like occurs in a device, a server can manage an occurrence situation of the defect, failure, or the like by receiving a notification on the defect, failure, or the like transmitted from the device. An occurrence situation of a defect, a failure, or the like includes, for example, a date and time at which the defect, failure, or the like has occurred, a device in which the defect, the failure, or the like has occurred, and specific details of the defect, the failure, or the like. Such a system is used to perform an appropriate job at an appropriate timing when a service worker visits a client as an after-sales service of a company having sold the device and performs a maintenance job on the client's device. Such a system has a function of registering details of a job performed for a defect, a failure, or the like by the service worker in the system in order to smoothly perform the maintenance job. Accordingly, the system is constructed as a system (hereinafter also referred to as a “repairing part notification system”) for increasing efficiency of the maintenance job by notifying of a part in which a defect, a failure, or the like estimated based on an error occurs, that is, a part on which repair or the like is to be performed.

A structure for reporting a maintenance job which has been performed by a service worker after an error has been resolved in order to improve accuracy of a process of estimating a portion on which repair or the like is to be performed has been proposed. For example, Japanese Unexamined Patent Publication No. 2021-33488 discloses a system that generates a job sequence in which details of a maintenance contract are reflected in advance and presents the generated job sequence to a user.

When a service worker has executed a plurality of jobs, there is a high likelihood that a job executed later may be more effective for an error. Accordingly, in order to improve accuracy of a repairing portion notification system, the service worker needs to be made to record an execution sequence. However, a service worker who focuses on resolving an error has to be made to record details of jobs at a time point at which the error has not been resolved, which is troublesome.

### SUMMARY

Therefore, the present disclosure was made in consideration of the aforementioned circumstances to provide a system and a method that can allow the system side to estimate a sequence in which a maintenance job of a device is executed without causing a user to record the sequence while executing the maintenance job and which can be used for feedback in estimation of a job.

In order to achieve the aforementioned objective, a system according to the present disclosure includes a storage, one or more memories storing instructions, and one or more processors capable of executing the instructions causing the system to estimate a target portion of a first job, details of the first job, and a priority of the first job for each of the at least one first job required for resolving an error of a device based on error data indicating details of the error having occurred in the device and history data associated with the device, provide first job data indicating the target portion of the first job, the details of the first job, and the priority of the first job for each of the at least one first job, receive second job data indicating a target portion of a second job and details of the second job for each of the at least one second job which is executed on the device to resolve the error of the device, and store, in the storage, a sequence in which the at least one second job identified based on the second job data is executed for use as feedback in estimation of the first job.

Further features of the present disclosure will become apparent from the following description of exemplary embodiments with reference to the attached drawings.

### BRIEF DESCRIPTION OF THE DRAWINGS

FIG. 1 is a diagram illustrating an example of an entire configuration of a system according to an embodiment.

FIG. 2 is a diagram illustrating an example of a hardware configuration of a repairing portion notification server included in the system according to the embodiment.

FIG. 3 is a diagram illustrating an example of a hardware configuration of a printer included in the system according to the embodiment.

FIG. 4 is a diagram illustrating an example of a software configuration of the system according to the embodiment.

FIG. 5 is a flowchart illustrating an example of a repairing component estimating process according to the embodiment.

FIG. 6 is a flowchart illustrating an example of the repairing component estimating process according to the embodiment.

FIG. 7 is a diagram illustrating an example of a graphical user interface of a repairing sequence display screen according to the embodiment.

FIG. 8 is a diagram illustrating an example of a graphical user interface of a repairing sequence details screen according to the embodiment.

FIG. 9 is a diagram illustrating an example of a graphical user interface of an executed treatment list transmission screen according to the embodiment.

FIG. 10 is a flowchart illustrating an example of a process flow of an execution sequence estimating process according to the embodiment.

FIG. 11 is a diagram illustrating an example of a graphical user interface of an execution sequence transmission screen according to the embodiment.

### DESCRIPTION OF THE EMBODIMENTS

Hereinafter, an embodiment of the present disclosure will be described with reference to the accompanying drawings. The following embodiment does not limit the present disclosure described in the appended claims. All combinations of features described in the following embodiment cannot be said to be essential to a unit for solving the disclosure.

A system according to an embodiment includes a storage, one or more memories storing instructions, and one or more processors capable of executing the instructions causing the system to, estimate a target portion of a first job, details of the first job, and a priority of the first job for each of the at least one first job required for resolving an error of a device based on error data indicating details of the error having occurred in the device and history data associated with the device, provide first job data indicating the target portion of the first job, the details of the first job, and the priority of the first job for each of the at least one first job receive second job data indicating a target portion of a second job and details of the second job for each of the at least one second job which is executed on the device to resolve the error of the device, and store, in the storage, a sequence in which the at least one second job identified based on the second job data is executed for use as feedback in estimation of the first job.

The estimation may include that the at least one second job is performed in the sequence based on the priority of the first job.

The estimation may include a target component of the first job, and that the first job on the component is executed in the sequence of cleaning of the component, adjustment of the component, and replacement of the component.

The estimation may include a target component of the first job and a priority of the first job for the component.

The instructions may further cause the system to manage the number of components replaced in the first job to resolve an error that has occurred in the past in correlation with information for identifying the component.

The first job data indicating the target portion of the first job and the details of the first job may be provided in the order of decreasing priorities of the first job.

The estimation may include an estimation of the sequence in which the second job is executed based on details of the second job which has already been executed and the context of a plurality of second jobs.

The device may be an image processing device having a printing function.

The error of the device may be an error based on one component associated with a printing process in the image processing device.

Hereinafter, specific examples of the system and the method will be described with reference to the accompanying drawings.

### First Embodiment

### System Configuration

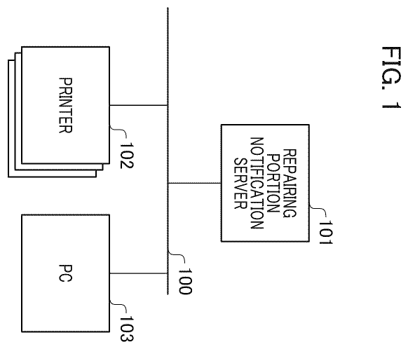

FIG. 1 is a diagram illustrating an example of an entire configuration of a system according to an embodiment. A device management system has a configuration in which a repairing portion notification server 101, a printer 102, and a personal computer (PC) 103 can communicate with each other via a network 100.

The network 100 is, for example, a so-called communication network which is realized by a local area network (LAN) or a wide area network (WAN) such as the Internet or a telephone line and is not particularly limited as long as transmission and reception of data are possible.

The repairing portion notification server 101 receives error information indicating an error having occurred in the printer 102 from the printer 102 and estimates repairing component information of one or more repairing components for resolving the error. The repairing portion notification server 101 manages results of component replacement performed in the market for the same error that has occurred in the past as market results and determines a priority of a repairing component to be treated based on the market results.

The printer 102 is an example of an image forming device such as a printer or an MFP and has functions such as a printing function, a FAX function, a copying function, and a scanner function. When it is detected that an error has occurred, the printer 102 transmits the error information including device information to the repairing portion notification server 101. The printer 102 may have a configuration including a plurality of printers.

The PC 103 is an example of an information processing device, and a predetermined operating system (OS) which is not illustrated is installed therein. A browser 331 which will be described later is also installed in the PC 103. The PC 103 transmits a repairing component information acquisition request of the printer 102 to the repairing portion notification server 101 via the browser 331, receives repairing component information from the repairing portion notification server 101, and displays a graphical user interface (GUI).

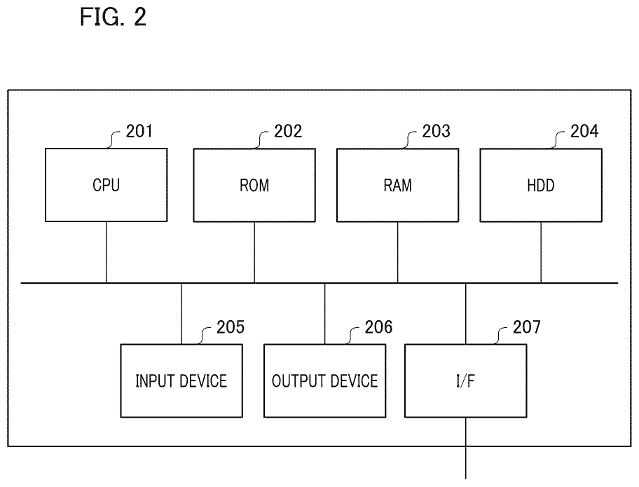

In the following description, the functions of the repairing portion notification server 101 described in the present disclosure may be realized by a single server or a single virtual server or may be realized as a management system including a plurality of servers or a plurality of virtual servers. Alternatively, the functions of the repairing portion notification server 101 may be realized by causing a plurality of virtual servers to be executed in a single server. In this case, the repairing portion notification server 101 is included as one server function in a management system which is constructed over the Internet. The repairing portion management system may be designed over the cloud based on cloud computing technology. In this case, at least some hardware of a computer illustrated in FIG. 2 may be used as hardware resources which are provided to a virtual server associated with the cloud computing technology.

FIG. 2 is a diagram illustrating an example of a hardware configuration of the repairing portion notification server included in the system according to the embodiment. Specifically, FIG. 2 is a block diagram illustrating the hardware configuration of the repairing portion notification server 101 illustrated in FIG. 1.

A CPU 201 directly or indirectly controls devices (in addition to a read only memory (ROM) and a random access memory (RAM) which will be described later) connected to an internal bus and executes a program for realizing the present disclosure. In the ROM 202, a basic input/output system (BIOS) is stored. The RAM 203 is a direct storage device and is used as a work area of the CPU 201 or used as a temporary storage area to which a software module for realizing the present disclosure is loaded.

A hard disk drive (HDD) 204 is an indirect storage device and stores an OS which is basic software or software modules. The HDD 204 may be replaced with a solid state drive (SSD). An input device 205 is, for example, a keyboard or a pointing device. An output device 206 is, for example, a display. An I/F 207 is connected to the network 100. (TC: The drawing doesn't show that 207 is connected to network 100)

In the hardware, the BIOS is executed by the CPU 201 that has been activated, or the OS is loaded in an executable manner to the RAM 203 from the HDD 204. The CPU 201 frequently loads various types of software modules which will be described later from the HDD 204 to the RAM 203 in an executable manner in response to an operation of the OS. Various types of software modules are executed and operated by the CPU 201 in cooperation with the devices. The I/F 207 is connected to the Internet 100 or the local network 101 and controlled by the CPU 201 in response to the operation of the OS to realize communication based on the communication unit.

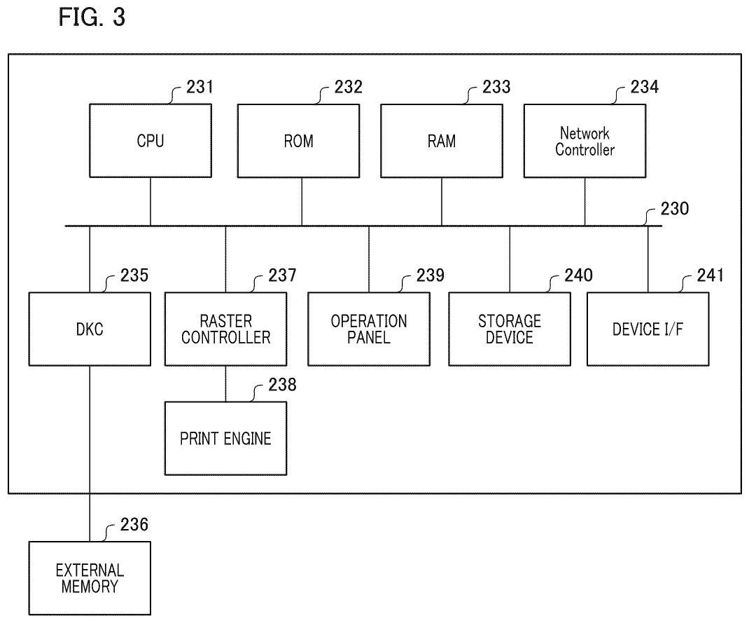

FIG. 3 is a diagram illustrating an example of a hardware configuration of a printer included in the system according to the embodiment. Parts except a print engine 238 may be referred to as a controller serving as a control system of the printer. The hardware constituents are connected to a system bus 230.

The CPU 231 controls the whole device and comprehensively controls access to various devices connected to the system bus 230. This control is based on a control program stored in the ROM 232 or a control program and resource data (resource information) stored in an external memory 236 connected via a disk controller (DKC) 235. The RAM 233 serves as a main memory, a work area, or the like of the CPU 231 and is configured to extend a memory capacity using an optional RAM connected to an extension port which is not illustrated.

A storage device 240 is an external storage unit serving as a large-capacity memory. An operation panel (an operation unit) 239 displays a screen and receives an operation instruction from a user via the screen. Buttons for performing operations such as setting of an operation mode or the like of the printer 103, displaying of an operation situation of the printer 103, and designating of content data to be printed and a display unit such as a liquid crystal panel or the like. A network controller 234 is, for example, a network interface card (NIC), and exchange of data with an external device is performed via the network controller 234.

A raster controller 237 is, for example, a controller for converting printing data described in page description language (PDL) to image data. A print engine 238 forms an image on a sheet based on the image data input from the raster controller 237 using known printing techniques. Examples of a very suitable execution system include print engines such as electromagnetic photography system (a laser beam system), an inkjet system, and a sublimation (thermal transfer) system. A device I/F 241 is a connection I/F to an external device which can be connected using a USB.

### Software Configuration

Operations of a server and a printer will be described below with reference to a configuration diagram of the repairing portion notification system. These operations are realized by causing a CPU to execute a program stored in a memory of each device. Schemas or data of tables described below are examples, and formats or the like of schemas or various types of data in the tables are not limited thereto.

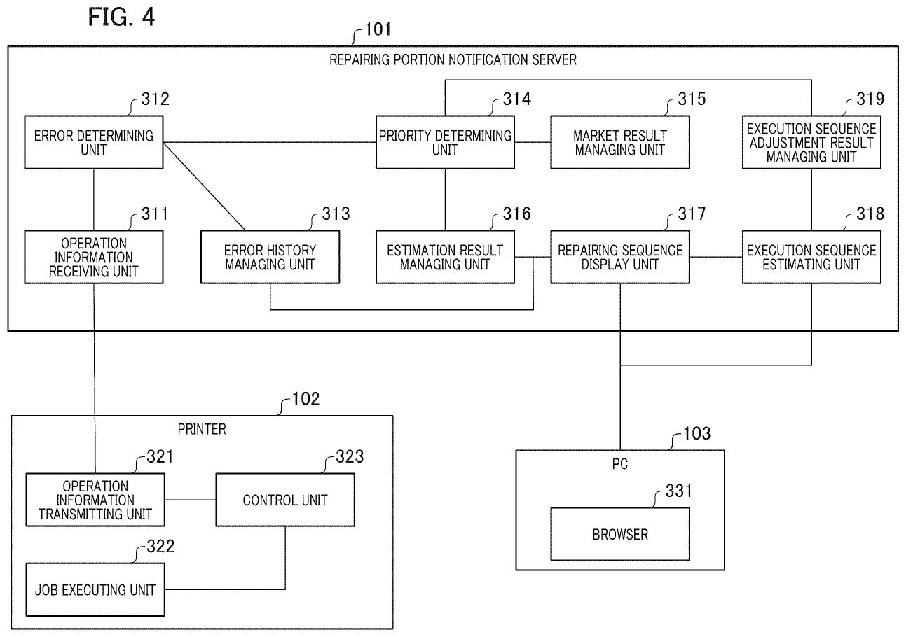

FIG. 4 is a diagram illustrating an example of a software configuration of the system according to the embodiment. The repairing portion notification server 101 includes an operation information receiving unit 311, an error determining unit 312, an error history managing unit 313, a priority determining unit 314, a market result managing unit 315, an estimation result managing unit 316, a repairing sequence display unit 317, an execution sequence estimating unit 318, and an execution sequence estimation result managing unit 319.

The operation information receiving unit 311 receives operation information from the printer 102. Information received by the operation information receiving unit 311 includes error information indicating an error and operation information of the printer 102.

When the error information is received from the operation information receiving unit 311, the error determining unit 312 acquires an error history which is information of errors which occurred in the past in the printer in which the error has occurred from the error history managing unit 313. The error determining unit 312 identifies one or more repairing components for resolving the error along with the received error information and transmits the repairing components along with the error information as a determination result to the priority determining unit 314 which will be described later. At this time, when the error determining unit 312 cannot identify a repairing component for a certain reason, for example, because an error for a certain error code cannot be identified, the error determining unit 312 transmits the determination result “no repairing component is identified” along with the error information to the priority determining unit 314 which will be described later. The error determining unit 312 stores the error information received from the printer 102 as an error history in the error history managing unit 313.

The error history managing unit 313 stores and manages the error information received from the printer 102 as an error history. An example of a part of the error history managed by the error history managing unit 313 is described in Table 1.

TABLE 1

| | | Model | | Counter | Occurrence |
|---|---|---|---|---|---|
| Error ID | Device ID | number | Error code | value | date and time |
| Err-001 | DEV-0000001 | Model-001 | E009001 | 5000 | 2022 Sep. 1 |
| | | | | | T12:34:56Z |
| Err-002 | DEV-0000002 | Model-002 | E002-0002 | 1500 | 2022 Sep. 3 |
| | | | | | T00:00:00Z |
| Err-003 | DEV-0000001 | Model-001 | E003-0001 | 2000 | 2022 Sep. 1 |
| | | | | | T00:12:34Z |

The error history includes an error ID for uniquely identifying an error, a device ID for uniquely identifying a printer in which an error has occurred, a model number indicating a model type, an error code indicating a type of the occurring error, a counter value which is the number of prints at the time of occurrence of the error, and an error occurrence date and time.

When the determination result is received from the error determining unit 312, the priority determining unit 314 acquires a market result which matches a model number and an error code of the error information included in the determination result from the market result managing unit 315. The priority determining unit 314 ranks “repairing components with a high likelihood of resolving the error” in a sequence of decreasing the number of component replacement in the market result of which the component number matches the repairing component included in the determination result and stores the ranked repairing sequence as an estimation result in the estimation result managing unit 316. The priority determining unit 314 reflects a later repairing turn in execution turns stored in the execution sequence estimation result managing unit 319 as a “repairing turn of a repairing component with a higher likelihood of resolving of the error” in estimation.

The market result managing unit 315 stores and manages collections of the model number, the error codes, and the number of component replacement for each component number in all the component replacing jobs executed by service workers to resolve errors occurred in the past. Table 2 describes an example of a part of the market result managed by the market result managing unit 315.

TABLE 2

| Model | | Component | Replacement |
|---|---|---|---|
| number | Error code | number | number |
| Model-001 | E009001 | Part1-111 | 510 |
| Model-001 | E009001 | Part2-222 | 228 |
| Model-001 | E009001 | Part3-333 | 92 |
| Model-001 | E009001 | Part4-444 | 20 |
| Model-001 | E009001 | Part5-555 | 150 |
| Model-002 | E009001 | Part1-111 | 123 |
| Model-001 | E002-0002 | Part5-555 | 2000 |

The market result includes a model number indicating a model type, an error code which is a type of an error having occurred, a component number indicating a component which has been replaced for the error, and the number of replacement which is a component replacement result number. The estimation result managing unit 316 stores and manages the estimation result which is the ranked repairing sequence prepared by the priority determining unit 314. Table 3 describes an example of a part of the estimation result managed by the estimation result managing unit 316.

TABLE 3

| Device ID | Error ID | Component number | Priority |
|---|---|---|---|
| DEV0000001 | Err-001 | Part1-111 | 51.0 |
| DEV0000001 | Err-001 | Part2-222 | 22.8 |
| DEV0000001 | Err-001 | Part3-333 | 9.2 |
| DEV0000001 | Err-001 | Part4-444 | 2.0 |
| DEV0000002 | Err-002 | Part1-111 | 900 |

The estimation result includes a device ID, an error ID, a component number of a repairing component for the error, and a priority indicating the ranking of a component to be repaired. In this embodiment, it is assumed that repairing priorities of components decease in the order of decreasing the priority values. An example of a priority calculating method will be described in description of a repairing component estimating process described later with reference to FIG. 4.

When a repairing sequence acquisition request including a device ID and an error ID is received from the browser 331 of the PC 103, the repairing sequence display unit 317 acquires an error history with a matching device ID and a matching error ID from the error history managing unit 313. The repairing sequence display unit 317 acquires an estimation result with the matching device ID and the matching error ID from the estimation result managing unit 316, generates a repairing sequence display screen, and returns the generated repairing sequence display screen to the browser 331. The repairing sequence display screen displayed by the repairing sequence display unit 317 transitions to a repairing sequence details screen 600 which will be described later in response to pressing of a transition button 506 which will be described later.

When an execution sequence estimation request including a component name and treatment is received from the browser 331 of the PC 103, the execution sequence estimating unit 318 estimates an execution sequence based on the context of jobs and stores the estimation result in the execution sequence estimation result managing unit 319.

The execution sequence estimation request includes a treatment list including a model number indicating a model type, a device ID, an error ID which is a type of an error having occurred, a component number of a component replaced for the error, executed treatment, and a priority ranking. Table 4 describes an example of a part of the treatment list. The priority ranking is a ranking of a priority ranked based on a threshold value. By replacing the numerical priorities with alphabet priorities, a user can intuitively understand what treatment is to be first executed.

TABLE 4

| Model | | | Component | | Priority |
|---|---|---|---|---|---|
| number | Device ID | Error ID | number | Treatment | ranking |
| Model-001 | DEV-0000001 | Err-001 | Part1-111 | Adjustment | A |
| Model-001 | DEV-0000001 | Err-001 | Part1-111 | Cleaning | B |
| Model-001 | DEV-0000001 | Err-001 | Part1-111 | Replacement | C |
| Model-001 | DEV-0000001 | Err-001 | Part2-222 | Adjustment | A |

The execution sequence estimation result includes a treatment list including a model number indicating a model type, a device ID, an error ID which is a type of an error having occurred, a component number of a component replaced for the error, executed treatment, a priority ranking, and an execution turn. Table 5 describes an example of a part of the execution sequence estimation result.

TABLE 5

| Model | Device | | Component | | Priority | Execution |
|---|---|---|---|---|---|---|
| number | ID | Error ID | number | Treatment | ranking | turn |
| Model-001 | DEV- | Err-001 | Part1-111 | Cleaning | B | 1/4 |
| | 0000001 | | | | | |
| Model-001 | DEV- | Err-001 | Part1-111 | Adjustment | A | 2/4 |
| | 0000001 | | | | | |
| Model-001 | DEV- | Err-001 | Part1-111 | Replacement | C | 3/4 |
| | 0000001 | | | | | |
| Model-001 | DEV- | Err-001 | Part2-222 | Adjustment | A | 4/4 |
| | 0000001 | | | | | |

The printer 102 includes an operation information transmitting unit 321, a job executing unit 322, and a control unit 323. The operation information transmitting unit 321 transmits error information having occurred in the printer 102 collected by the control unit 323 which will be described later to the repairing portion notification server 101.

The job executing unit 322 executes a job input to the printer 102. For example, when a printing job is input, the job executing unit 322 performs a printing process based on the printing job.

The control unit 323 detects an error occurring in the printer 102, collects error information, and transmits the error information to the repairing portion notification server 101 via the operation information transmitting unit 321.

### Repairing Component Estimating Process

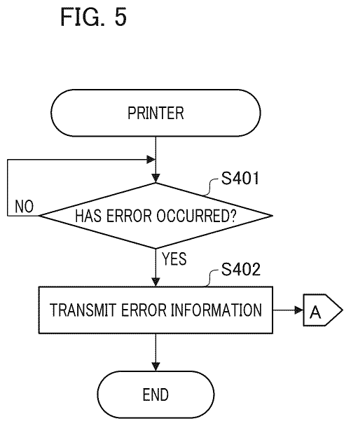

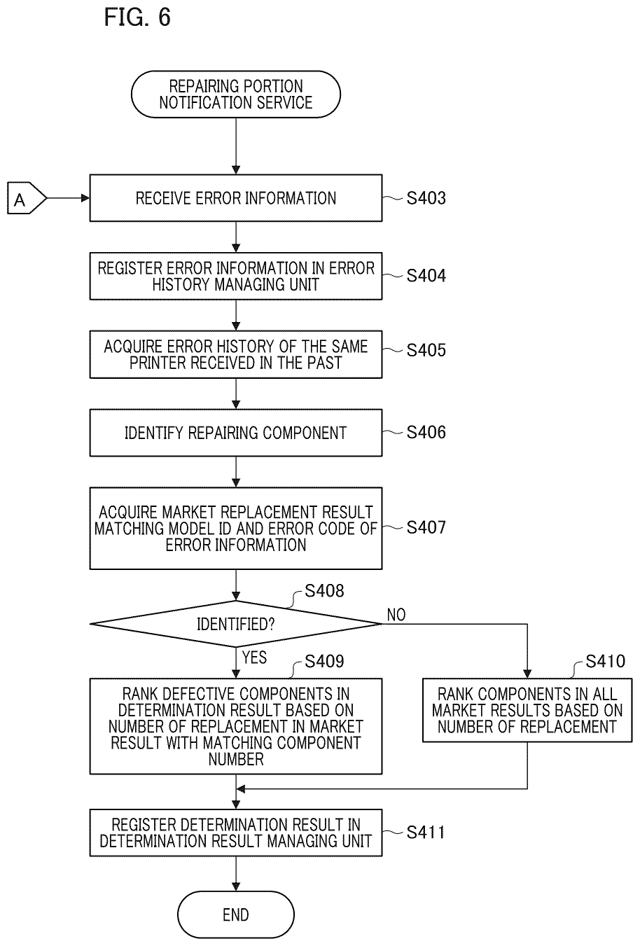

FIGS. 5 and 6 are flowcharts illustrating an example of a repairing component estimating process according to the embodiment. The flowchart illustrated in FIG. 5 and the flowchart illustrated in FIG. 6 are connected by a coupler A.

In Step S401, the control unit 323 of the printer 102 detects whether an error has occurred in the printer 102. In Step S402, when occurrence of an error is detected, the operation information transmitting unit 321 of the printer 102 transmits error information to the repairing portion notification server 101.

In Step S403, the operation information receiving unit of the repairing portion notification server 101 receives the error information. The transmitted error information includes the error ID, the device ID, the model number, the error code, the counter value, and the error occurrence date and time included in the error history of Table 1.

In this embodiment, an example in which the counter value is included in the error information is described, but, for example, a method of receiving the counter value as counter information from the printer 102 using information other than the error information and correlating the counter information with the error information may be employed.

In Step S404, the error determining unit 312 registers the received error information as an error history in the error history managing unit 313.

In Step S405, the error determining unit 312 acquires an error history matching the device ID included in the received error information. For example, when the device ID included in the error information is “DEV0000001,” records of the first row and the third row in Table 1 can be acquired.

In Step S406, the error determining unit 312 calculates a list of a plurality of component numbers indicating repairing components to be treated in order to resolve the error based on a rule base using the error information received from the printer 102 and the error history acquired from the error history managing unit 313.

In Step S406, the error determining unit 312 may not be able to identify repairing components to be treated. An example of this case is an error for which a rule is not present in the rule base. At this time, the error determining unit 312 outputs a list of empty component numbers indicating that determination is not possible.

In this embodiment, an example in which the error determining unit 312 employs a method using a rule base based on the received error information and error histories occurred in the past in the sample device is described, but identification of a repairing component is not limited thereto. For example, estimation using supervised machine learning including deep learning may be performed.

In Step S407, the priority determining unit 314 acquires a market replacement result matching the model number and the error code in the error information from the market result managing unit 315. For example, when the model number and the error code included in the error information are “Model-001” and “E009001,” records of the first to fifth rows in Table 2 can be acquired.

In Step S408, the priority determining unit 314 checks whether the error determining unit 312 has identified a repairing component. Specifically, when a list of empty component numbers is output in Step S406, the priority determining unit 314 determines that a repairing component has not been identified and performs Step S410 which will be described later. When a list of empty component numbers is not output, the priority determining unit 314 determines that a repairing component has been identified and performs Step S409 which will be described later.

In Step S409, the priority determining unit 314 acquires a replacement number matching the component number from the market result acquired in Step S407 for each component number included in the list of component numbers calculated in Step S406. Then, in Step S409, the priority determining unit 314 correlates priorities which is “(number of replacement of repairing component/total number of replacement of all components replaced for error)×100” with the component numbers. That is, the priority determining unit 314 calculates the priorities in the units of components such that the total sum of the priorities of all the components replaced for the error code occurred in a certain model type is 100%.

In this embodiment, the priority is calculated as a ratio of the number of replacement of repairing components to the total number of replacement of all the repairing components to be treated, but a priority calculating method is not limited to the method according to this embodiment and may be any method.

For example, when the list of component numbers is [Part1-111, Part2-222, Part3-333, Part4-444] and the market result acquired in Step S407 corresponds to the first to fifth rows in Table 2, the total number of replacement of all the replaced components is 900 which is a sum of the numbers of replacement in the market result.

At this time, the priority of the component number “Part1-111” is calculated as “(510/900)×100=51.0.” Similarly, the priorities of the other component numbers “Part2-222,” “Part3-333,” and “Part4-444” are calculated as “22.8,” “9.2,” and “2.0.”

In Step S410, the priority determining unit 314 calculates the priorities of all the records in the market result acquired in Step S407 using the same method as in Step S409. For example, it is assumed that the market result acquired in Step S407 includes the first to fifth rows in Table 2. In this case, the priorities of 5 component numbers “Part1-111,” “Part2-222,” “Part3-333,” “Part4-444,” and “Part5-555” included in the market result are calculated, and the component numbers and the priorities are correlated using the priorities as the estimation result. Specific examples of the priorities will be omitted herein.

In Step S411, the priority determining unit 314 registers the component numbers and the priorities calculated in Step S409 or S410 along with the device ID and the error ID as the estimation result in the estimation result managing unit 316. For example, the estimation result for the component numbers and the priorities calculated in Step S409 corresponds to the first to fourth rows in Table 3.

As an example of a realization method, a server (function) for performing the processes of Steps S403 to S404, a server (function) for performing the processes of Steps S405 to S406, and a server (function) for performing the processes of Steps S407 to S411 which are performed by the repairing portion notification server 101 can be separated and mounted in the management system (by asynchronously performing the functions or the like).

Through the aforementioned description, it is possible to estimate a repairing component for an error having occurred in the printer 102.

In this embodiment, identification of a repairing component to be treated (Step S406) and calculation of the priorities (Step S409 or S410) are performed at a timing at which error information from the printer 102 is received, but the present disclosure is not limited thereto. For example, a method of performing only identification of a repairing component at the timing at which the error information is received and performing calculation of the priorities at a timing at which the repairing sequence estimation request from the browser 331 is received may be employed.

In this embodiment, a display sequence determining method is described in the units of components using the number of component replacement, but, for example, a treatment number of cleaning or adjustment in addition to component replacement may be stored in the market result managing unit 315 and an estimation result in which the components and the priorities of treatment are ranked in the treatment units of replacement, cleaning, and adjustment may be displayed.

### GUI of Repairing Component Display Screen

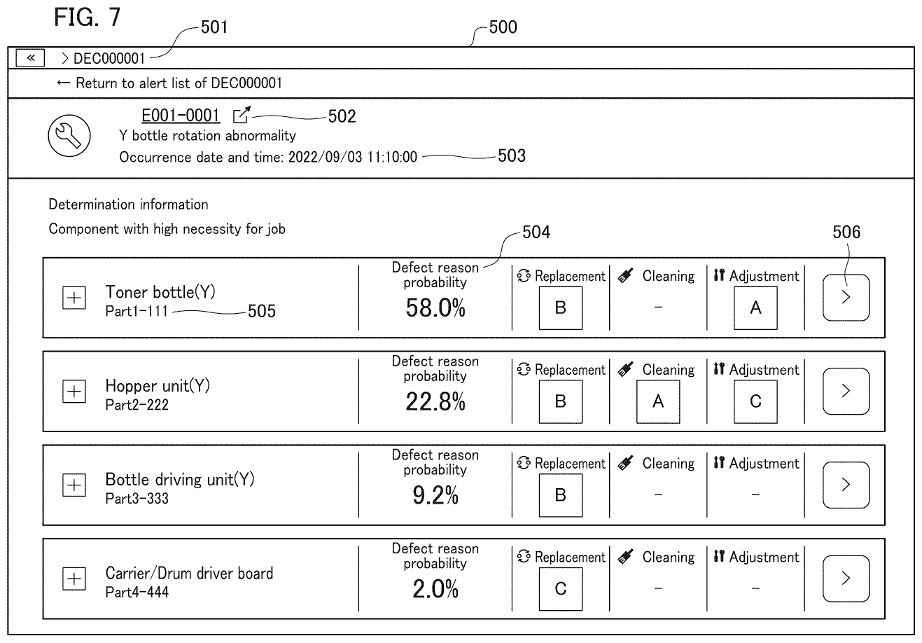

FIG. 7 is a diagram illustrating an example of a graphical user interface of a repairing sequence display screen according to the embodiment. When the repairing sequence display unit 317 of the repairing portion notification server 101 having received the repairing sequence acquisition request including a device ID and an error ID from the browser 331 of the PC 103 returns a response to the browser 331, the screen is displayed on the browser 331. The method of causing the repairing sequence display unit 317 to generate the repairing component display screen has been described above and thus will be omitted.

The repairing portion notification system according to the present disclosure is a system that displays a repairing sequence for resolving an error for each error having occurred. The repairing sequence display screen 500 includes a repairing sequence for an error designated via the browser 331.

The repairing sequence display screen 500 displays an error history and an estimation result managed by the repairing portion notification server 101. The device ID 501 represents a device ID in the error history matching an error ID designated by the repairing sequence acquisition request and an error ID in the error history managed by the error history managing unit 313. The error code 502 represents an error code in the error history matching the error ID designated by the repairing sequence acquisition request and the error ID in the error history managed by the error history managing unit 313.

The occurrence date and time 503 represents an occurrence date and time in the error history matching the error ID designated by the repairing sequence acquisition request and the error ID in the error history managed by the error history managing unit 313.

The repairing component 504 represents an estimation result in which the error ID indicated by the repairing sequence acquisition request is located in the estimation result managed by the estimation result managing unit 316. The repairing sequence display unit 317 can present what component is to be repaired to a user by sorting the rankings of the estimation result represented by the repairing component 504 in the order of decreasing the priorities of the estimation result.

In this embodiment, the estimation result is displayed in the order of priorities, but, for example, when there are a plurality of estimation results, a component to be treated in the estimation result in which the priority is greater than a threshold value may be additionally displayed using an icon or a message on the repairing sequence display screen 500.

The component number 505 represents a component number in the estimation result managed by the estimation result managing unit 316. The transition button 506 is a button for causing the screen to transition to a repairing sequence details screen 600 which will be described later. With this configuration, it is possible to rank and display repairing components for resolving an error having occurred in the printer in the order of decreasing the likelihoods of resolving the error.

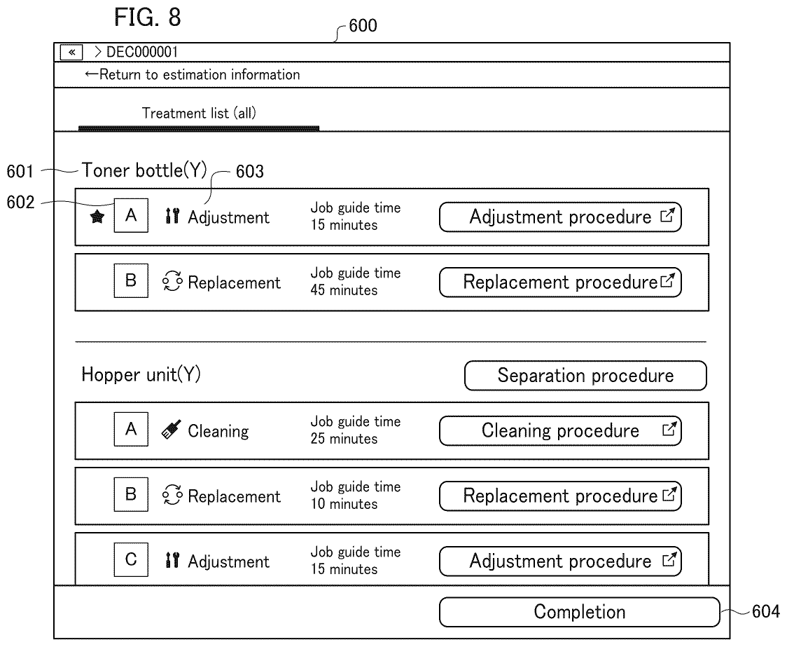

FIG. 8 is a diagram illustrating an example of a graphical user interface of a repairing sequence details screen according to the embodiment. The repairing sequence details screen 600 is a screen in which a repairing sequence for an error designated via the browser 331 is included and treatment of components with high priorities is sorted in the order of decreasing the priorities of the components.

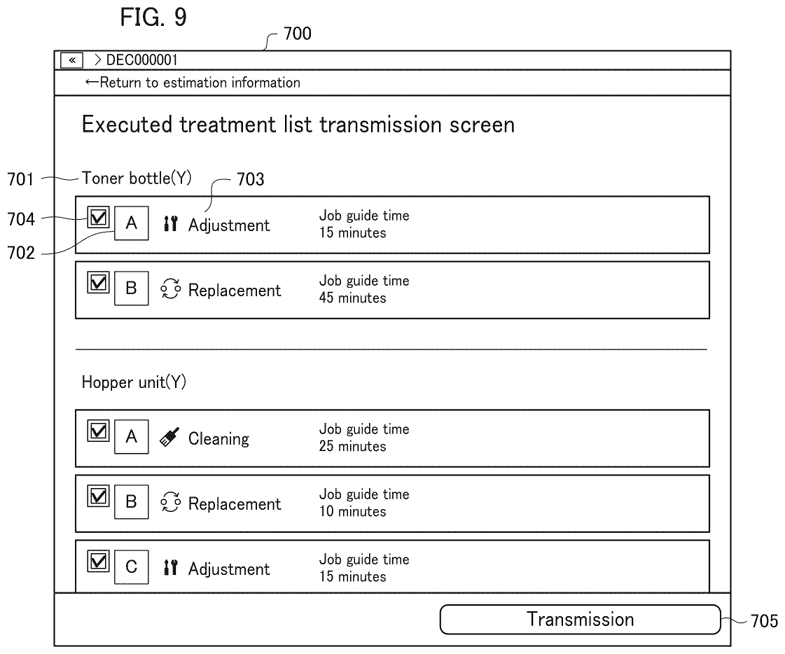

The completion button 604 is a button which is pressed by a user having ascertained that an error has been resolved by the treatment which causes the screen to transition to an executed treatment list transmission screen illustrated in FIG. 9 which will be described later.

With this configuration, it is possible to display the order of the components with high priorities, and the treatments with high priorities for each component.

FIG. 9 is a diagram illustrating an example of a graphical user interface of the executed treatment list transmission screen according to the embodiment. The executed treatment list transmission screen 700 is a screen in which a repairing sequence for an error designated via the browser 331 is included and treatment of components with high priorities is sorted in the order of decreasing the priorities of the components. Means for displaying the repairing component 701, the priority 702, and the repairing sequence 703 are the same as described above, and thus description thereof will be omitted. An executed treatment designation checkbox 704 is a checkbox for allowing a user to designate treatment executed until the error is resolved. The executed treatment list transmission button 705 is a button for preparing a treatment list described above with reference to Table 4 for a component designated via the executed treatment designation checkbox 704, adding the prepared executed treatment designation checkbox to the execution sequence estimation request, and transmitting the execution sequence estimation request to the repairing portion notification server 101.

With this configuration, an execution sequence can be designated using the checkbox by a user, and the execution sequence estimation request can be transmitted to the repairing portion notification server 101.

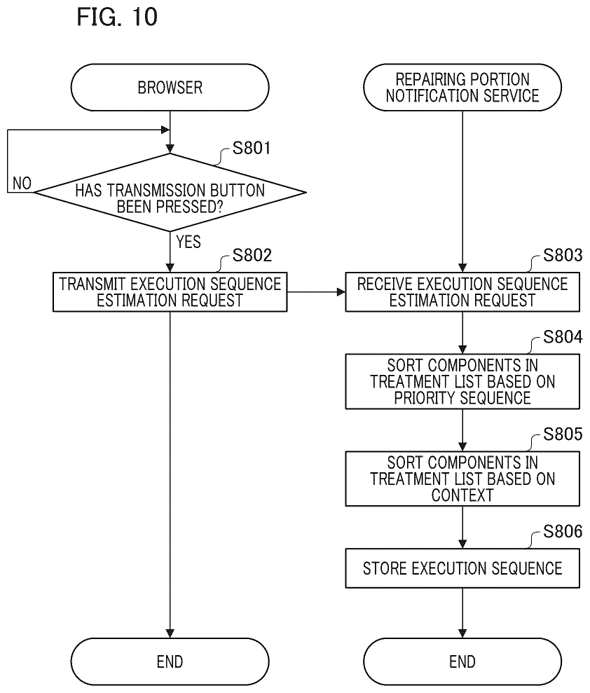

FIG. 10 is a flowchart illustrating an example of a process flow of an execution sequence estimating process according to the embodiment. In Step S801, it is detected whether a user has pressed the executed treatment list transmission button 705 on the executed treatment list transmission screen displayed on the browser 331. In Step S802, when pressing of the transmission button has been detected, the executed treatment list transmission screen 700 transmits an execution sequence estimation request including the treatment list described above with reference to Table 4 to the repairing portion notification server 101. In Step S803, the execution sequence estimating unit 318 of the repairing portion notification server 101 receives the execution sequence estimation request. In Step S804, the execution sequence estimating unit 318 sorts the treatment list included in the execution sequence estimation request in the order of decreasing the priorities of treatment for the components with high priorities. Table 6 describes an example of the treatment list sorted in Step S804.

TABLE 6

| Model | | | Component | | Priority |
|---|---|---|---|---|---|
| number | Device ID | Error ID | number | Treatment | ranking |
| Model-001 | DEV-0000001 | Err-001 | Part1-111 | Adjustment | A |
| Model-001 | DEV-0000001 | Err-001 | Part1-111 | Cleaning | B |
| Model-001 | DEV-0000001 | Err-001 | Part1-111 | Replacement | C |
| Model-001 | DEV-0000001 | Err-001 | Part2-222 | Adjustment | A |

In Step S805, the execution sequence estimating unit 318 sorts the treatment list included in the execution sequence estimation request based on the context of treatment in the same component. The context of treatment is, for example, the priority rankings in which, when the treatment performed on components includes “replacement,” “cleaning,” and “adjustment,” (1) “cleaning,” (2) “adjustment,” and (3) “replacement” are generally predicted to be performed in this order. The context of treatment may include a job other than “cleaning,” “adjustment,” and “replacement.” The context of treatment may be defined for each component and may be stored in a DB or the like or may be referred to.

Table 7 describes an example of the treatment list sorted in Step S805.

TABLE 7

| Model | | | Component | | Priority |
|---|---|---|---|---|---|
| number | Device ID | Error ID | number | Treatment | ranking |
| Model-001 | DEV-0000001 | Err-001 | Part1-111 | Cleaning | B |
| Model-001 | DEV-0000001 | Err-001 | Part1-111 | Adjustment | A |
| Model-001 | DEV-0000001 | Err-001 | Part1-111 | Replacement | C |
| Model-001 | DEV-0000001 | Err-001 | Part2-222 | Adjustment | A |

In Step S806, the execution sequence estimating unit 318 stores the estimated execution sequence (Table 5) in the execution sequence estimation result managing unit 319.

As an example of a realization method, a server (function) for performing the process of Step S803, a server (function) for performing the processes of Steps S804 to S805, and a server (function) for performing the process of Step S806 which are performed by the repairing portion notification server 101 can be separated and mounted in the management system by asynchronously performing the functions or the like.

With this configuration, it is possible to sort the received treatment list based on the priorities and the context of treatment and to estimate the execution sequence.

### Second Embodiment

In the first embodiment, since a user cannot be made to ascertain whether the execution sequence estimation result stored in Step S806 is correct or not, improvement of accumulating corrections and using the corrections to improve estimation accuracy cannot be achieved. In a second embodiment, an example in which an estimation result is presented to a user and is corrected by the user will be described. The same description as in the first embodiment will be omitted. An execution ranking 901 represents a ranking in which each procedure has been executed.

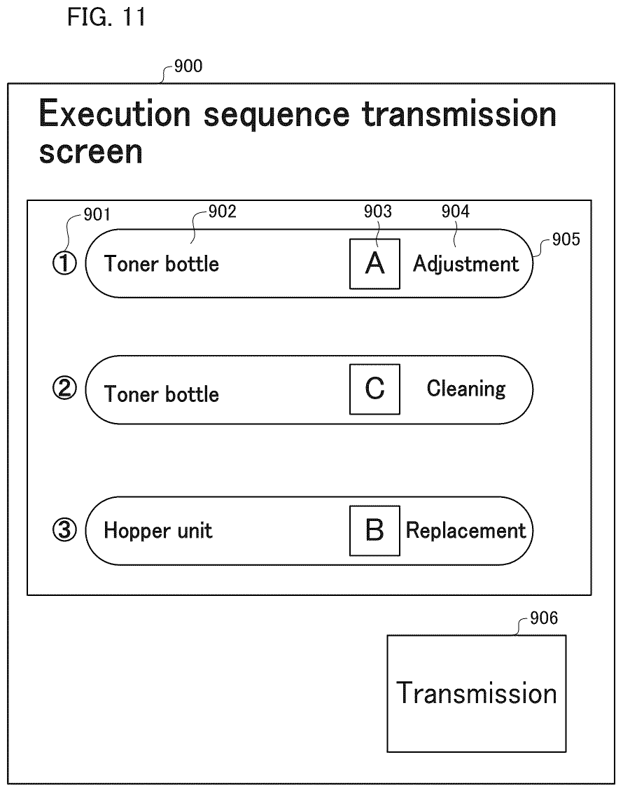

FIG. 11 is a diagram illustrating an example of a graphical user interface of an execution sequence transmission screen according to this embodiment. An execution sequence transmission screen 900 includes the estimation result from the execution sequence estimating unit 318 of which an example is described in Table 5 on a screen to which the screen transitions by pressing the executed treatment list transmission button 705.

The execution ranking 901 represents an execution turn. The repairing component 902, the priority 903, and the repairing sequence 904 are the same as described above, and thus description thereof will be omitted. An execution sequence editing block 905 is an area which is vertically movable through a browser operation and can be edited by moving the position of the execution sequence editing block 905 to the replacement execution ranking 901 when a user edits the execution sequence presented by the repairing portion notification system.

The execution sequence transmission button 906 is a button for preparing a treatment list including the execution rankings 901 of the treatment, the repairing component 902, the priority 903, and the repairing sequence 904 adding the treatment list to the execution sequence storage request, and transmitting the execution sequence storage request to the repairing portion notification server 101. Table 8 describes an example of a treatment list corrected by a user in which the sequence of cleaning and replacement in the execution sequence presented as details of Table 5 has been corrected by a user.

TABLE 8

| Model | Device | | Component | | Priority | Execution |
|---|---|---|---|---|---|---|
| number | ID | Error ID | number | Treatment | ranking | turn |
| Model-001 | DEV- | Err-001 | Part1-111 | Replacement | C | 1/4 |
| | 0000001 | | | | | |
| Model-001 | DEV- | Err-001 | Part1-111 | Adjustment | A | 2/4 |
| | 0000001 | | | | | |
| Model-001 | DEV- | Err-001 | Part1-111 | Cleaning | B | 3/4 |
| | 0000001 | | | | | |
| Model-001 | DEV- | Err-001 | Part2-222 | Adjustment | A | 4/4 |
| | 0000001 | | | | | |

The process of storing the execution sequence storage request is the same as described above in Step S806, and thus description thereof will be omitted.

With this configuration, the repairing portion notification system can present an estimated sequence of treatment executed by a user to the user and be instructed by the user until an error of the device is resolved, whereby it is possible to enable feedback to the estimation process and to enable estimation with higher accuracy.

### Other Embodiments

The present disclosure can also be realized as a process of supplying a program for realizing one or more functions of the aforementioned embodiments to a system or a device via a network or a recording medium and causing one or more processors of a computer of the system or the device to read and execute the program. The present disclosure can also be realized by a circuit for realizing one or more functions, for example, an application-specific integrated circuit (ASIC).

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-081803, filed May 17, 2023, which is hereby incorporated by reference herein in its entirety.

What is claimed is:

1. A system comprising:
a storage;
one or more memories storing instructions; and
one or more processors capable of executing the instructions causing the system to:
estimate a target portion of a first job, details of the first job, and a priority of the first job for each of the at least one first job required for resolving an error of a device based on error data indicating details of the error having occurred in the device and history data associated with the device;
provide first job data indicating the target portion of the first job, the details of the first job, and the priority of the first job for each of the at least one first job;
receive second job data indicating a target portion of a second job and details of the second job for each of the at least one second job which is executed on the device to resolve the error of the device; and
store, in the storage, a sequence in which the at least one second job identified based on the second job data is executed for use as feedback in estimation of the first job.

2. The system according to claim 1, wherein the estimation includes that the at least one second job is performed in the sequence based on the priority of the first job.

3. The system according to claim 1, wherein the estimation includes a target component of the first job, and that the first job on the component is executed in the sequence of cleaning of the component, adjustment of the component, and replacement of the component.

4. The system according to claim 1, wherein the estimation includes a target component of the first job and a priority of the first job for the component.

5. The system according to claim 1, wherein the instructions further cause the system to manage the number of components replaced in the first job to resolve an error that has occurred in the past in correlation with information for identifying the component.

6. The system according to claim 1, wherein the first job data indicating the target portion of the first job and the details of the first job are provided in the order of decreasing priorities of the first job.

7. The system according to claim 1, wherein the estimation includes an estimation of the sequence in which the second job is executed based on details of the second job which has already been executed and the context of a plurality of second jobs.

8. The system according to claim 1, wherein the device is an image processing device having a printing function.

9. The system according to claim 8, wherein the error of the device is an error based on one component associated with a printing process in the image processing device.

10. A method of estimating sequence of a first job of a device, the method comprising:
estimating a target portion of the first job, details of the first job, and a priority of the first job for each of the at least one first job required for resolving an error of the device based on error data indicating details of the error having occurred in the device and history data associated with the device;
providing first job data indicating the target portion of the first job, the details of the first job, and the priority of the first job for each of the at least one first job;
receiving second job data indicating a target portion of a second job and details of the second job for each of the at least one second job which is executed on the device to resolve the error of the device; and
storing, in the storage, a sequence in which the at least one second job identified based on the second job data is executed for use as feedback in estimation of the first job.

11. The method according to claim 10, wherein the estimation includes that the at least one second job is performed in the sequence based on the priority of the first job.

12. The method according to claim 10, wherein the estimation includes a target component of the first job, and that the first job on the component is executed in the sequence of cleaning of the component, adjustment of the component, and replacement of the component.

13. The method according to claim 10, wherein the estimation includes a target component of the first job and a priority of the first job for the component.

14. The method according to claim 10, wherein the instructions further cause the system to manage the number of components replaced in the first job to resolve an error that has occurred in the past in correlation with information for identifying the component.

15. The method according to claim 10, wherein the first job data indicating the target portion of the first job and the details of the first job are provided in the order of decreasing priorities of the first job.

16. The method according to claim 10, wherein the estimation includes an estimation of the sequence in which the second job is executed based on details of the second job which has already been executed and the context of a plurality of second jobs.

17. The method according to claim 10, wherein the device is an image processing device having a printing function.

18. The method according to claim 17, wherein the error of the device is an error based on one component associated with a printing process in the image processing device.
